(19) United States
(12) Patent Application Publication
(10) Pub. No.: US 2007/0275136 A1
(43) Pub. Date: Nov. 29, 2007

(54) Microwave Cooking Device for Crisping

(76) Inventor: Gary Hopkins SR., Scottsburg, IN (US)

Correspondence Address: Carrithers Law Office, 6060 Dutchman's Lane, Suite 140, Louisville, KY, 40205, US

(21) Appl. No.: 10/579,424

(22) PCT Filed: May 12, 2004
(86) PCT No.: PCT/US04/14908

§ 371 Date: May 10, 2007

Related U.S. Application Data
(60) Provisional application No. 60/519,667, filed on Nov. 13, 2003.

(51) Int. Cl. A23L 3/00

(52) U.S. Cl. 426/234; 99/646 C

(57) ABSTRACT

A microwave cooking device 10 for crisping food is described. The device 10 includes an internal crisping container 14 including a susceptor and outer packaging 30. In one embodiment, the internal crisping container 14 is a heat seal closed cooking bag having an inner surface coated with a susceptor film. The cooking bag defines a plurality of apertures 24 enabling moisture to escape the cooking bag. The outer packaging 30 contains the internal crisping container 14 and includes at least one aperture 36 enabling moisture to escape the microwave cooking device 10. In one embodiment, the outer packaging 30 includes at least one aperture-forming strip 32 that may be pealed away to define an aperture 36 in the outer packaging 30.

### CROSS-REFERENCE TO RELATED APPLICATION

This application claims the benefit of U.S. Provisional Application No. 60/519,667, filed Nov. 13, 2003, which is incorporated herein by reference.

### BACKGROUND OF THE INVION

The present invention relates to the field of cooking devices, and, more particularly, to cooking devices for use in a microwave oven for cooking and crisping meats, vegetables, and other food products.

Consumers often prefer to cook food in a microwave oven rather than conventional ovens because of the reduced cooking time required to heat foods in a microwave oven. Consumers also want to be provided with the opportunity to cook pre-packaged food products in the package in which they were purchased without the hassle of transferring the food from one container to the next.

Unfortunately, when microwave cooking foods, which are preferably served browned and crispy, such as breaded fish or French fries, they tend to become soggy. As such, many people consider microwave cooking to be problematic and generally undesirable.

One method for improving the texture and consistency of these foods when cooking using a microwave oven is to use susceptors to assist in cooking the food, for example, the susceptors described in U.S. Pat. No. 5,614,259, which is incorporated herein by this reference.

Susceptors are employed in the preparation of food products in microwave ovens to convert some of the microwave energy to heat in order to assist in cooking the food by conduction, convection and/or radiant heating, as well as microwave radiation. Specifically, susceptors are often used to assist in the preparation of food, which, when cooked desirably, should have a browned or crispy exterior surface. Susceptors are applied to the cooking surfaces of utensils, portions of packaged food products, and a food wrap for a food product.

Since susceptors are brought into contact with foods intended for human consumption, it is necessary to encapsulate the microwave interactive material within films or the like that are approved for contact with food, thus resulting in a multi-layer susceptor product (sometime referred to hereinafter as “susceptor film”). Customarily, the susceptor product comprises a base sheet, such as paper or cardboard, a thin film or foil of microwave interactive material, such as aluminum and other selected metals and alloys, and a heat resistant barrier film overlying the metal film or foil.

The multi-layer sheet is generally wrapped around or placed adjacent food being packaged in a microwave cooking container to facilitate cooking of the food product. In such an arrangement, the food product is not completely surrounded by the susceptor film, for example, when the susceptor film is wrapped around the food product, the ends of the food product do not receive the benefits of being exposed to the susceptor film. However, if the ends were closed off, steam generated from the food would accumulate, causing the food product to become soggy.

It is therefore the paramount object of the present invention to provide a microwave cooking device for crisping a food product, which allows the food product to be surrounded by the susceptor film, to maximize crisping and browning, without the risk of becoming soggy.

This and other objects and advantages of the present invention will become apparent upon a reading of the following description.

### DESCRIPTION OF THE DRAWINGS

FIG. 1 is a perspective view of an embodiment of a cooking device made in accordance with the present invention, with the internal crisping container removed from the outer packaging 10 for clarity.

### DETAILED DESCRIPTION OF THE INVENTION

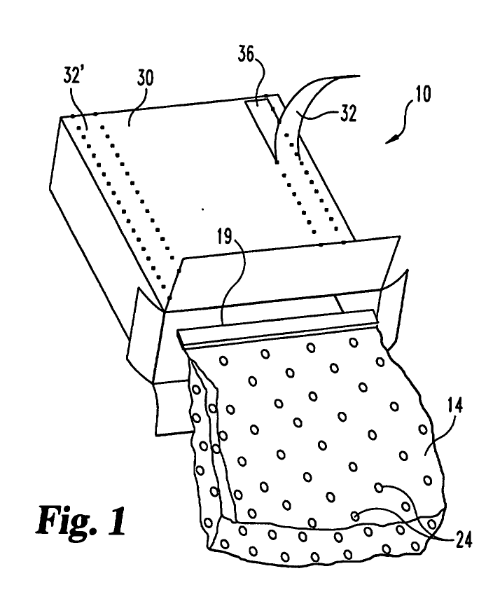

The present invention is a microwave cooking device for crisping food product. With reference to FIG. 1, the device 10 generally includes an outer packaging 30 and an internal crisping container 14, having susceptor film incorporated within the volume defined by the container 14 to facilitate browning and crisping. For example, it is preferred that the inner surface (not shown) of the container 14 be coated with susceptor film. Alternatively, at least one discrete piece of susceptor film may be placed within the volume defined by the device 10.

The container 14 has an open cooking environment to allow moisture generated during preparation to escape, keeping the food product from becoming soggy. An open cooking environment is one which does not have a fixed volume while the food product is being prepared (i.e., while the food product is being cooked in the microwave oven using the device 10 of the present invention). For example, as shown in FIG. 1, it is preferred that the container 14 define a plurality of openings 24 which readily allow moisture to escape from the container 14 during preparation, but are not large enough to allow the food product to escape the container 14.

After food product has been delivered to the crisping container 14, the container 14 is preferably placed within the outer packaging 30, which is sealed to maintain the integrity of the food product during storage. Although the container 14 may be removed from the outer packaging 30 prior to preparation, it is preferred that one or more apertures 36 are created in the outer packaging 30 just prior to preparation to allow the moisture generated from the food product to escape, first through the openings 24 defined by the container 14, and then through the apertures 36 defined by the outer packaging 30. The outer packaging 30 preferably includes one or more aperture forming strips 32, 32′, which may be grasped and pealed away from the outer packaging 10, leaving the one or more apertures 36.

Of course, the cooking device 10 of the present invention may take various forms as long as the crisping container 14 has an open cooking environment and incorporates susceptor film within the volume defined by the container 14. For example and with reference to FIG. 1, the container 14 may be a heat sealed cooking bag which is compatible with vertical fill automated machines. A vertical fill automated machine is commonly used to deliver food product to a storage bag. These automated machines have the capacity to fill numerous storage bags at a very rapid rate, making them popular devices in the food packaging industry. As such, it is preferred that the container 14 of the present invention has an overall shape that allows it to be loaded into and used with a standard vertical fill automated machine as is commonly used in the food storage and preparation industry. The vertical fill automated machine is used to deliver food product to the container 14 through the opening 19 and thereafter seal the opening 19. The opening 19 is preferably sealed using a heat seal, such that the food product within the container 14 will not escape during storage and preparation.

Of course, the depicted embodiment is merely exemplary and it is contemplated that containers having a variety of structural features could be used without departing from the spirit and scope of the present invention. It will be obvious to those skilled in the art that other modifications may be made to the invention described herein without departing from the spirit and scope of the present invention.

1. A microwave cooking device for crisping food product, comprising:
an internal crisping container including an outer surface and an inner surface defining a volume therein, wherein a susceptor is incorporated in the volume defined by the internal crisping container, wherein the internal crisping container is constructed and arranged to enable moisture to escape the internal crisping container during microwave cooking; and
an outer packaging for holding the internal crisping container, the outer packaging defining at least one aperture constructed and arranged to enable moisture to escape the outer packaging during microwave cooking.

2. The device of claim 1, wherein the aperture is formed prior to microwaving the food product using at least one aperture-forming strip.

3. The device of claim 1, wherein the inner surface is coated with a susceptor film.

4. The device of claim 1, wherein one discrete piece of susceptor film is incorporated within the volume.

5. The device of claim 1, wherein the outer and inner surfaces of the internal crisping container define at least one aperture.

6. The device of claim 5, wherein the at least one aperture defined in the internal crisping container has a diameter smaller than portions of the food product contained inside the internal crisping container.

7. The device of claim 1, wherein the internal crisping container further defines an opening for transferring the food product to and from the internal crisping container.

8. The device of claim 7, wherein the opening is sealed using a heat seal.

9. The device of claim 1, wherein the internal crisping container is a cooking bag.

10. The device of claim 9, wherein the cooking bag is heat sealed.

11. The device of claim 10, wherein the cooking bag is compatible with a vertical fill automated machine.

12. A method for crisping food during microwaving including:
providing a microwave cooking device including a internal crisping container and an outer packaging, the internal crisping container incorporating a susceptor, wherein the internal crisping container is constructed and arranged to enable moisture to escape from the food contained therein, wherein the outer packaging includes at least one aperture-forming strip;
pealing the at least one aperture forming strip to define an aperture for assisting moisture in escaping the microwave cooking device;
placing the microwave cooking device in a microwave; and
microwaving the food.
